(19) United States
(12) Patent Application Publication
(10) Pub. No.: US 2012/0040229 A1
(43) Pub. Date: Feb. 16, 2012

(54) POWER BATTERY MODULE

(76) Inventors: Jianhua ZHU, Shenzhen (CN); Weixin Zheng, Shenzhen (CN); Hao Zhou, Shenzhen (CN)

(21) Appl. No.: 13/284,120

(22) Filed: Oct. 28, 2011

Related U.S. Application Data
(63) Continuation of application No. PCT/CN2010/071927, filed on Apr. 20, 2010.

(30) Foreign Application Priority Data
Apr. 30, 2009 (CN) 200920131272.X

(51) Int. Cl. H01M 2/10; H01M 10/50

(52) U.S. Cl. 429/120; 429/159

(57) ABSTRACT

The present disclosure provides a power battery module, comprising: a battery pack, an upper case, a lower case adapted to be mated with the upper case; at least a baffle plate longitudinally disposed at a lateral side of the battery pack between the lower case and the upper case to fix the battery pack in a lateral direction; and at least a boss formed on at least one of a bottom inner surface of the lower case and a top inner surface of the upper case in a lengthwise direction of the battery pack to fix the battery pack in the lengthwise direction.

### CROSS-REFERENCE TO RELATED APPLICATION

The present application is a continuation of International Application No. PCT/CN2010/071927, filed Apr. 20, 2010, designating the United States of America, which claims priority to Chinese Patent Application No.200920131272.X, filed in the State Intellectual Property Office of the P. R. China on Apr. 30, 2009, the entire contents of both of which are incorporated herein by reference.

### FIELD OF THE INVENTION

The present invention relates to a battery assembly, more particularly to a power battery module, especially for a power vehicle.

### BACKGROUND

With improvement of the life quality, the requirement of a power vehicle such as a power automobile has increased. Meanwhile, the problems of global environmental pollution and petroleum shortage have become worse. Traditional energy such as petroleum and gas will soon become exhausted. In the forgoing background, the HEV/EV (hybrid energy vehicle/electric vehicle) was invented. The main power source of the HEV/EV is a lithium ion cell or other new green energy. Green energy helps to relief the problem of global environmental pollution and petroleum shortage. Nevertheless, there are many factors to be considered for designing a battery module, not only to ensure that the performance of the battery module meets the requirements of the auto, but also to ensure that the battery is safe and reliable. Besides, the power battery module and the auto need to be matched with each other to reduce the volume and weight of the whole car, which is closely related to the structure of the power battery module.

FIG. 1 shows a conventional power battery module structure. The power module comprises a plurality of cells 4 connected together. A diaphragm 5′ is disposed between every two adjacent cells. The battery module is fastened by at least a baffle plate 1′ and at least a pull rod 2′. The structure of the battery module is firmly secured in the X-axis and Z-axis directions as shown in FIG. 1, but not in the Y-axis direction. The battery module fixed in an auto suffers from shocks from different directions, making the cells become loosened in the Y-axis direction. Thus, the conventional battery module cannot be secured firmly, reducing the reliability and safety of the battery module.

### SUMMARY OF THE INVENTION

The present invention is directed to solve at least one of the problems in the art. Accordingly, a power battery module needs to be provided, which secures a battery pack in the power battery module firmly in all the three dimensions with a simple structure.

According to an embodiment of the disclosure, a power battery module is provided, comprising: a battery pack comprising a plurality of cells connected in series or parallel; an upper case; a lower case adapted to be mated with the upper case to form a chamber in which the battery pack is located, so that the battery pack is held stably in a height direction of the battery pack; at least a baffle plate longitudinally disposed at a lateral side of the battery pack between the lower case and the upper case to fix the battery pack in a lateral direction; and at least a boss formed on at least one of a bottom inner surface of the lower case and a top inner surface of the upper case in a lengthwise direction of the battery pack to fix the battery pack in the lengthwise direction.

According to the present disclosure, the battery pack in the power battery module is firmly secured in three dimensions through the design of the upper case, the lower case and the inner configurations thereof, which improves the reliability of the power battery module and extends the lifespan of the battery pack. In addition, the volume of the vehicle power battery module is reduced and the assembly of the power battery module is simplified, so that the production and maintenance become easier.

### BRIEF DESCRIPTION OF THE DRAWINGS

The foregoing and other features and advantages of the invention will be better understood from the following detailed description of preferred embodiments of this disclosure when taken in conjunction with the accompanying drawings in which:

FIG. 1 shows a perspective view of a conventional power battery module.

FIG. 2 shows an exploded perspective view of a power battery module according to an embodiment of the present disclosure.

FIG. 3 shows a cross sectional view of a lower case of a power battery module according to an embodiment of the present disclosure along the Y-Z plane.

FIG. 4 shows a cross sectional view of a lower case of a power battery module according to an embodiment of the present disclosure along the X-Z plane.

FIG. 5 shows a top view of an upper case of a power battery module according to an embodiment of the present disclosure.

### DETAILED DESCRIPTION OF THE EMBODIMENTS

The aforementioned features and advantages of the invention as well as additional features and advantages thereof will be more clearly understood hereafter as a result of a detailed description of the following embodiments when taken in conjunction with the drawings.

X-axis, Y-axis and Z-axis directions are used as follows to indicate the directions of the power battery module. Nevertheless, these expressions are for illustration purposes rather than for limitation. A person skilled in the art can obviously use other terms as height, lengthwise and lateral directions for descriptive purposes, which are equivalent to X-axis, Y-axis and Z-axis directions respectively.

According to an embodiment of the disclosure, a power battery module 100 may be provided. The power battery module 100 may comprise a battery pack 9, an upper case 6, a lower case 7. The battery pack 9 may comprise a plurality of cells 91 connected in series or parallel. The lower case 7 may be adapted to be mated with the upper case 6 to form a chamber in which the battery pack 9 is located so that the battery pack 9 is securely held in a Z-axis direction of the battery pack 9. At least a baffle plate 8 may be longitudinally disposed at a lateral side of the battery pack 9 between the lower case 7 and the upper case 6 to fix the battery pack 9 in a Z-X plane. And at least a boss may be formed on at least one of a bottom inner surface of the lower case 7 and a top inner surface of the upper case 6 in a Y-axis direction of the battery pack 9 to fix the battery pack 9 in the Y-axis direction.

In the following description, the embodiments of the disclosure will be described in detail with reference to accompanying figures.

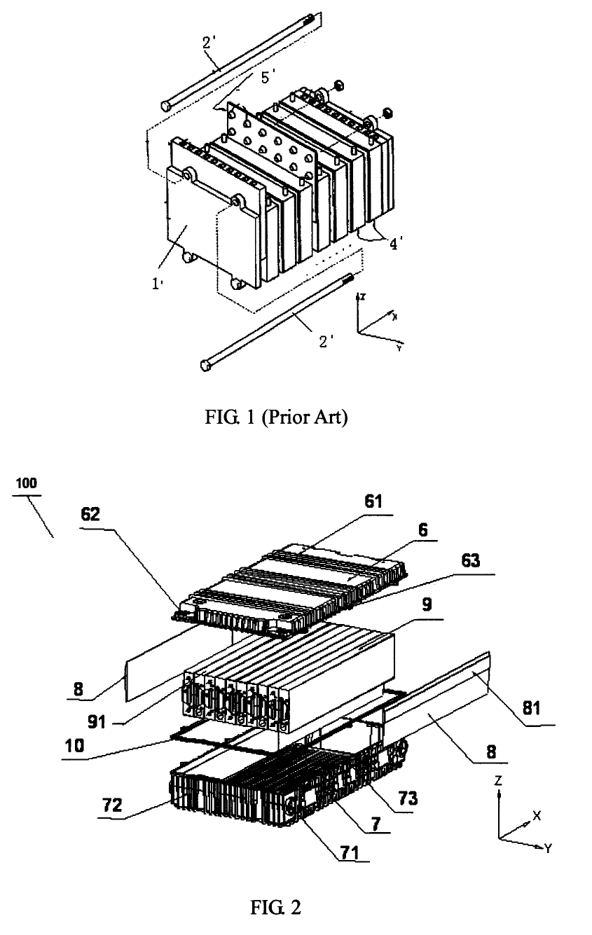

FIG. 2 shows an exploded perspective view of a power battery module according to an embodiment of the present disclosure. In FIG. 2, a pair of baffle plates 8 are longitudinally disposed beside two outermost cells 91 respectively, and are interposed between the lower case 7 and the upper case 6. As shown in FIG. 4, a plurality of bosses 76, such as two, may be disposed on the bottom inner surface of the lower case 7 which are parallel to the bottom surface of the battery pack 9. According to another embodiment of the disclosure, the bosses 76 may be formed on the top inner surface of the upper case 6 which are parallel to the top surface of the battery pack 9. The upper case 6 and the lower case 7 are configured to securely position the battery pack 9 in the Z-axis direction. The baffle plates 8 are configured to securely position the battery pack 9 in the Y-axis direction. The bosses 76 as shown in FIG. 4 are configured to securely position the battery pack 9 in the X-axis direction.

In some embodiments of the present disclosure, the boss 76 is disposed on a bottom inner surface of the lower case 7 and parallel to a front surface of the battery pack 9 as shown in FIG. 2, which securely positions the battery pack 9 in the X-axis direction. To position the battery pack 9 in the X-axis direction more reliably, a plurality of bosses 76 may be preferably disposed on the bottom inner surface of the lower case 7 and the top inner surface of the upper case 6 which are parallel to the front surface of the battery pack 9 as shown in FIG. 2.

In some embodiments of the present disclosure, the material of the baffle plate 8 may be plastic, which is an insulator with suitable mechanical strength, heat distortion temperature, low-temperature embrittlement property and chemical corrosion resistance. The baffle plate 8 may be fixed with a protruding portion 81 formed on the lateral side of the baffle plate 8, and with a mating groove 75 formed on the lateral side of the lower case 7. Alternatively, the mating groove 75 may be formed on the lateral side of the upper case 6. The baffle plate 8 may be configured to be a plate with a trapezoid cross section with a thickness of approximately 1.5-10 mm.

To avoid the contact between the neighboring cells 91, a diaphragm may be interposed between the neighboring cells. The diaphragm is made of insulating plastic material with mechanical strength, wear resistance, low-temperature embrittlement property and chemical corrosion resistance adapted to the requirement of the battery pack 9.

When the power battery module 100 is damaged, the liquid in the power battery module 100 leaks out. Thus, when a power vehicle runs in a water environment, for example, when a hybrid car passes through a flooded road, the power battery module 100 may still work normally. To avoid liquid leakage and ensure the reliability of the power battery module 100, in some embodiments of the present disclosure, at least one of the upper case 6 and the lower case 7 may further comprise a sealing member 10 which may be disposed on the mating surfaces of the upper case 6 or/and the lower case 7. To improve the sealing effect, at least one of the upper case 6 and the lower case 7 may further comprise a sealing groove 74, with the sealing member 10 being disposed in the sealing groove 74. The material of the sealing member 10 may be rubber, with proper distortion and chemical corrosion resistance properties.

A pair of electrode outlets 62 are disposed on one edge of the upper case 6 which are configured for the connection of the anode and cathode of the cells 91. Furthermore, a gas passing opening 71 may be formed on the lower case 7 for battery temperature modulating.

The upper case 6 may be connected with the lower case 7 in a snap-fit manner. Alternatively, the upper case 6 and the lower case 7 may comprise a plurality of connecting holes, disposed on the edges of the upper case 6 and the lower case 7. The connecting holes on the upper case 6 are positioned corresponding to the connecting holes on the lower case 7. A connecting member, such as a stud bolt, may penetrate through a connecting hole to connect the upper case 6 with the lower case 7 accordingly. Thus, the battery pack 9 is securely positioned in the Z-axis direction.

The upper case 6 and the lower case 7 may be formed with strengthening ribs on their external surfaces. The strengthening ribs enhance the mechanical strength of the power battery module 100 to prevent the power battery module 100 from being damaged in a collision. The strengthening ribs may be disposed vertically or horizontally on the external surfaces of the upper case 6 and the lower case 7 according to the stress suffered on the upper case 6 and the lower case 7. The thickness of the upper case 6 and the lower case 7 may be about 3-5 mm, and the thickness of the strengthening ribs may be about 5-12 mm. The material of the upper case 6 and the lower case 7 may be plastic with suitable mechanical strength, heat distortion temperature, low temperature embrittlement and chemical corrosion resistance properties. With the structure of the plastic baffle plate 8, the upper case 6 and the lower case 7, the weight of the power battery module 100 is reduced, and thus the weight of the whole power vehicle is reduced accordingly.

The figures will be described in detail as follows. FIG. 2 shows an exploded perspective view of a power battery module 100 according to an embodiment of the present disclosure. In the FIG. 2, the upper case 6 may comprise a plurality of thread connecting holes 63, disposed at each edge of the upper case 6. The lower case 7 comprises a plurality of thread connecting holes 73, formed on each edge of the lower case 7. The thread connecting holes 63 on the upper case 6 are positioned corresponding to the thread connecting holes 73 on the lower case 7. The upper case 6 is connected with the lower case 7 via bolts or screws through the connecting holes, thus securely positioning the battery pack 9 in the Z-axis direction, namely, in the width direction of the battery pack 9.

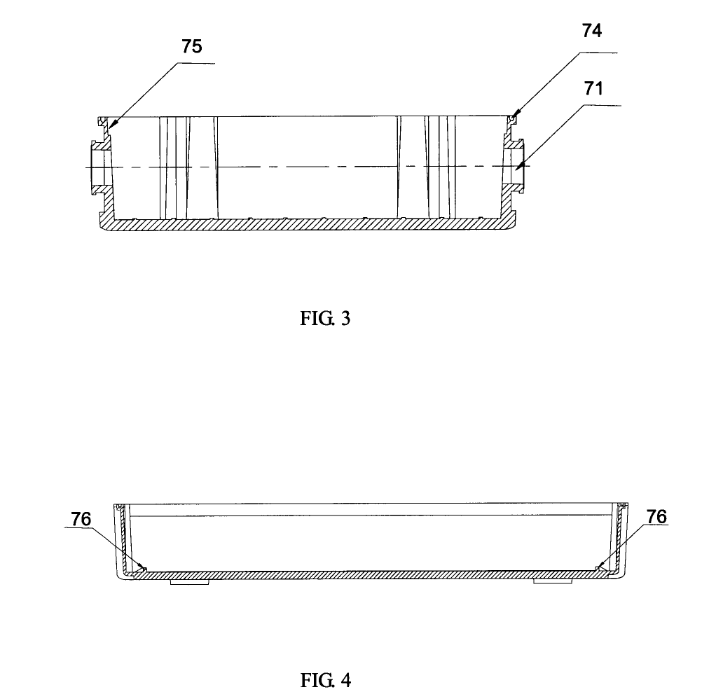

FIG. 3 shows a cross sectional view of the lower case 7 of the power battery module 100 according to an embodiment of the present disclosure along the Y-Z plane. According to FIG. 3, the lower case 7 further comprises the sealing groove 74, formed on the mating surface of the lower case 7 to accommodate the sealing member 10. In some embodiments of the disclosure, the upper case 6 also comprises a sealing groove formed on the mating surface of the upper case 6. The sealing member 10 is preferably disposed in the sealing groove 74 for a better sealing effect, to avoid the short circuit caused by battery liquid leakage due to collision.

The material of the upper case 6 may be polyphenylene oxide. The strengthening ribs 61 are formed on the upper case 6 through integral injection molding, to ensure the strength of the upper case 6. The material of the lower case 7 may be polyphenylene oxide and 10% glass fiber by weight. The strengthening ribs 71 are formed on the lower case 7 to ensure the strength of the lower case 7.

According to FIGS. 2 and 3, the baffle plates 8 are disposed at the two outermost cells of the battery pack 9 respectively. As shown in FIG. 2, the baffle plate 8 comprises the protruding portion 81. The low case 7 comprises the mating groove 75. The baffle plate 8 is fitted in the lower case 7 by the protruding portion 81 and the mating groove 75, and then the battery pack 9 is clamped between the baffle plates 8 accordingly. Thus, the battery pack 9 is securely positioned in the Y-axis direction, namely, in the thickness direction of the battery pack 9. In some embodiments of the disclosure, the upper case 6 also comprises a mating groove 75. The baffle plate 8 is fitted in the lower case 7 and the upper case 6 respectively.

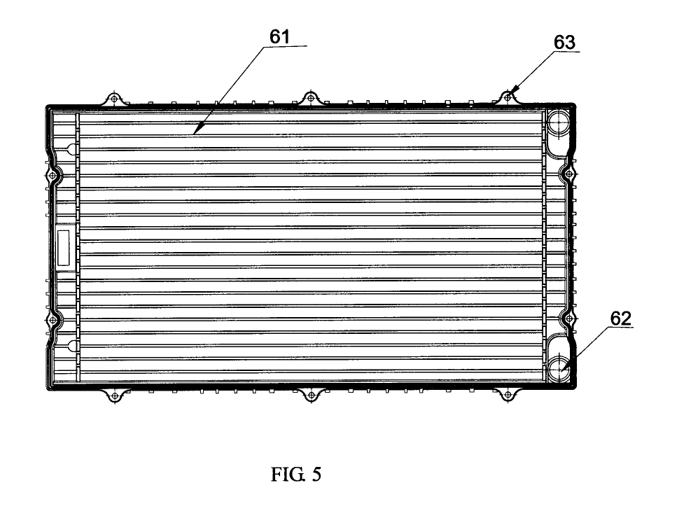

As shown in FIG. 5, the upper case 6 further comprises a pair of electrode outlets 62 disposed on one edge of the upper case 6 which are configured for the connection of the anode and cathode of the cells. As shown in FIG. 3, a gas passing opening 71 for modulating the temperature of the battery pack 9 is formed on one wall of the lower case 7.

FIG. 4 shows a cross sectional view of the lower case 7 of a power battery module 100 according to an embodiment of the present disclosure along the X-Z plane. As shown in FIG. 4, two bosses 76 are formed on the bottom inner surface of the lower case 7, and the bosses 76 are parallel to an edge (not shown in FIG. 4) of the battery pack 9. The battery pack 9 is fixed by the bosses 76 when the battery pack 9 is positioned in the lower case 7. And thus the battery pack 9 is securely positioned in the X-axis direction.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A power battery module, comprising:
a battery pack comprising a plurality of cells connected in series or parallel;
an upper case;
a lower case adapted to be mated with the upper case to form a chamber in which the battery pack is located so that the battery pack is held stably in a height direction of the battery pack;
at least a baffle plate longitudinally disposed at a lateral side of the battery pack between the lower case and the upper case to fix the battery pack in a lateral direction; and
at least a boss formed on at least one of a bottom inner surface of the lower case and a top inner surface of the upper case in a lengthwise direction of the battery pack to fix the battery pack in the lengthwise direction.

2. The power battery module according to claim 1, wherein a protruding portion is formed on the lateral side of the baffle plate, and a mating groove is formed on the lateral side of the upper case and/or the low case to fix the baffle plate.

3. The power battery module according to claim 2, wherein the baffle plate includes a plate with a trapezoid cross section.

4. The power battery module according to claim 2, wherein the baffle plate has a thickness of about 1.5-10 mm.

5. The power battery module according to claim 1, further comprising at least a diaphragm interposed between the neighboring cells.

6. The power battery module according to claim 1, further comprising a sealing member provided between the mating surfaces of the upper and lower cases.

7. The power battery module according to claim 6, wherein at least one of the upper case and the lower case is formed with a sealing groove.

8. The power battery module according to claim 1, wherein the upper case and the lower case are formed with a plurality of corresponding connecting holes so that the upper case and the lower case are fixed by a plurality of connecting members with each connecting member penetrating through each connecting hole.

9. The power battery module according to claim 1, wherein the upper case and the lower case are formed with strengthening ribs on external surfaces thereof respectively.

10. The power battery module according to claim 9, wherein the thickness of the upper and the lower cases is about 3-5 mm, and the thickness of the strengthening ribs is about 5-12 mm.

11. The power battery module according to claim 1, wherein a pair of the baffle plates are longitudinally disposed at both lateral sides of the battery pack.

12. The power battery module according to claim 1, wherein a plurality of bosses are formed on both of the bottom inner surface of the lower case and the top inner surface of the upper case in a lengthwise direction of the battery pack to fix the battery pack in the lengthwise direction.

13. The power battery module according to claim 1, wherein the upper case further comprises a pair of electrode outlets disposed on one edge of the upper case.

14. The power battery module according to claim 1, wherein the lower case further comprises a gas passing opening for modulating the temperature of the battery pack.

15. The power battery module according to claim 1, wherein the material of the upper case is polyphenylene oxide.

16. The power battery module according to claim 1, wherein the material of the lower case 7 comprises polyphenylene oxide and 10% glass fiber.

17. The power battery module according to claim 1, wherein the upper case and the lower case are connected in a snap-in manner.

18. A power battery module, comprising:
a battery pack comprising a plurality of cells connected in series or parallel;
an upper case;
a lower case adapted to be mated with the upper case to form a chamber in which the battery pack is located so that the battery pack is held stably in a height direction of the battery pack; and
at least a boss formed on at least one of a bottom inner surface of the lower case and a top inner surface of the upper case in a lengthwise direction of the battery pack to fix the battery pack in the lengthwise direction.
